(19) United States
(12) Patent Application Publication
(10) Pub. No.: US 2021/0097615 A1
(43) Pub. Date: Apr. 1, 2021

(54) TOOL FOR ASSISTING USER MODIFICATION OF A DYNAMIC USER PORTFOLIO

(71) Applicant: Wells Fargo Bank, N.A., San Francisco, CA (US)

(72) Inventors: Duke Lee Gunn, JR., Saint Louis, MO (US); Dennis Frederick Gutknecht, Charlotte, NC (US); Carter C. Hansen, Huntersville, NC (US); Matthew Fitzroy Lynch, Swansea, IL (US); Jonathan Paul Sidarous, House Springs, MO (US); Steven A. Jolley, Chester, SC (US)

(21) Appl. No.: 15/394,648

(22) Filed: Dec. 29, 2016

(51) Int. Cl. G06Q 40/06; G06F 17/27

(52) U.S. Cl. CPC G06Q 40/06; G06F 17/2705

(57) ABSTRACT

A system and related method provide items of interest to a user for modifying a current user collection of items and then modify the collection. User profile information is received from a user associated with the current user collection and then parsed into a plurality of user factors. A user factor weight is assigned for each of the user factors, and these are stored in a user profile memory. Element provider profile information associated with element provider profiles is received and parsed into element provider factors. Each of these are assigned a weight, and they are stored in an element provider profile memory. A matching score is determined between the user profile and a first element provider profile. An identifier of this provider and its matching score is output to the user. The current user collection is then modified to include an element related to a selected element provider.

### TECHNICAL FIELD

Described herein is a system and method that generally relate to a tool and related method for assisting a user in the modification of a user portfolio, based on weighted user interest factors.

### BACKGROUND

A user, may have a dynamic user collection containing user elements. One example might be an investor having an investment portfolio containing investment instruments. The investment portfolio is typically dynamic (time variant), and for an investment portfolio, may change based on a predicted return and associated risk with respect to elements already in the user portfolio versus elements available to include in the user portfolio. These considerations may not account for all of the user's interests.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a block diagram that illustrates a socially conscious investing system.

FIG. 2 is a screen shot in which an evaluation presents both the financial performance metrics along with the social performance metrics.

FIG. 3 is a flowchart that describes general process that may be used by the system.

FIG. 4 is a block diagram illustrating a machine that may be a computer on which various processes described herein may be performed.

FIG. 5 is a block diagram of a distributed system that may include a client-server architecture or cloud computing system.

### DETAILED DESCRIPTION

The system described herein is a tool and related method that may be used for assisting a user in modifying a dynamic collection of user items. Although the example used to illustrate this concept is an investor who has an investment portfolio containing investment items, the concepts are not limited to this particular example or implementation.

A computer-implemented method for providing items of interest to a user is described herein, comprising using a processor of a provider system for creating a current user collection comprising a plurality of current user elements. The method further comprises receiving user profile information from a user associated with the current user collection and then parsing the user profile information into a plurality of user factors. A user factor weight is assigned for each of the user factors based on the user profile information, and these factors along with their respective weights are stored in a user profile in a memory of the provider system. The method then comprises receiving element provider profile information associated with a plurality of element provider profiles, and parsing this information with an element opportunity evaluation component, into a plurality of element provider factors. Each of the element provider factors are assigned a weight based on the element provider profile information, and the plurality of element provider factors and their respective weights are stored in an element provider profile in the memory of the provider system. A matching score is determined between the user profile and a profile of a first element provider that is one of the element provider profiles by determining a degree of similarity between: a) the user factors with respective user factor weights, and b) first element provider factors with respective first element provider factor weights. An identifier of the first element provider and its matching score is output to the user, and the system receives a selected element identifier of the first element provider from the user. The current user collection is then modified to include an element identified by the selected element identifier and associated with the first element provider.

A provider system is also described herein comprising a hardware processor, a network interface connected to the hardware processor that is connected to a network, a non-volatile memory connected to the hardware processor and the network interface. The memory comprises a user collection comprising a plurality of user elements, a user profile comprising a plurality of user factors and their respective weights, a plurality of element provider profiles, each comprising a plurality of element provider factors and their respective weights. The memory also comprises instructions executable by the processor, comprising a user profile builder that is configured to receive user profile information from a user associated with the user collection, parse the user profile information into the plurality of user factors, assign the user factor weight for each of the user factors based on the user profile information, and store the plurality of user factors and their respective weights in the user profile that is stored in the memory. The memory also comprises an element opportunity evaluation component that is configured to receive element provider profile information associated with a plurality of element providers, parse the element provider profile information into the plurality of element provider factors, assign the element provider factor weight for each of the element provider factors based on the element provider profile information, store the plurality of element provider factors and their respective weights in the element provider profile that is stored in the memory, and determine a matching score between the user profile and a profile of a first element provider that is one of the element provider profiles. It does this by determining a degree of similarity between: a) the user factors with their respective user factor weights, and b) first element provider factors with respective first element provider factor weights. The instructions are further configured to output an identifier of the first element provider and its matching score to the user, receive a selected element identifier of the first element provider from the user, and modify the current user collection to include an element identified by the selected element identifier and associated with the first element provider.

A non-transitory computer-readable storage medium is also described herein, the computer-readable storage medium including instructions that when executed by a computer, cause the computer to execute the method described above.

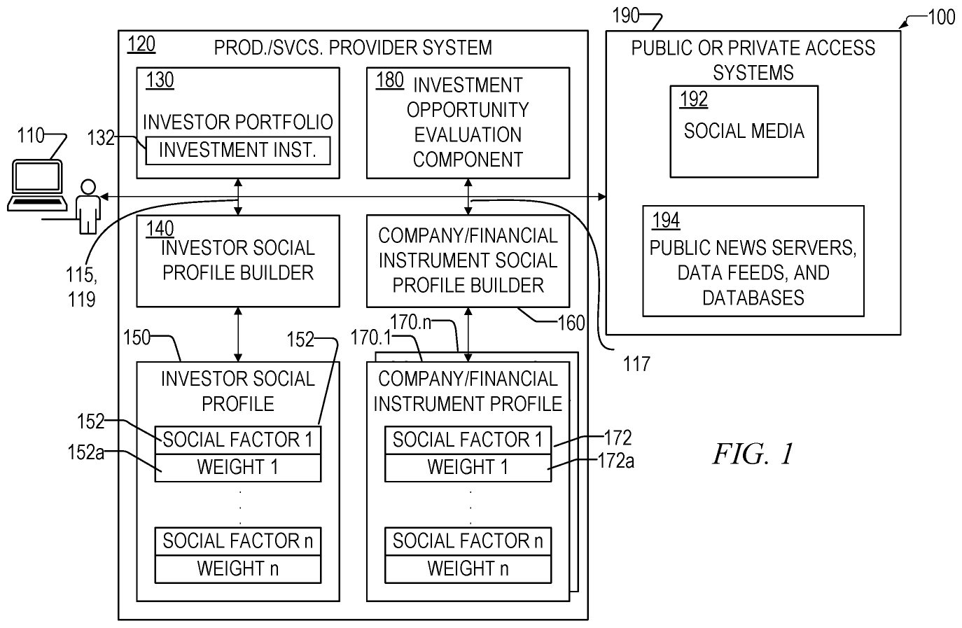

FIG. 1 is a block diagram that illustrates a system for assisting user modification of a dynamic user collection or investment portfolio that may be implemented as a socially conscious investing system 100. It may comprise three primary entities: a user or investor 110, a product/services provider system 120, and public systems 190 from which publicly available information may be obtained.

In the investor example described herein, the investor 110 may maintain their portfolio 130 containing stocks, mutual funds, bonds, and other investment instruments 132 with a financial products/services provider who will often associate a financial advisor with the investor. The provider system 120 may store information regarding the contents of the investor portfolio 130 along with tools to assist the investor in maintaining and managing their portfolio 130. Modern investors have a large choice in how they invest their money, and access to investment information is significantly facilitated by today's tools, such as the Internet, including web browsers and search engines. This access to information may allow investors to choose investments on a wide variety of criteria that may not have been possible in the past.

Additionally, the tools may provide an analysis on past performance of stocks and other investment instruments, and may further make predictions about performance. Investments may be categorized in a number of different ways (e.g., business sectors, geographic regions, etc.) so that the investor 110 may perform various risk/return investment analyses based on criteria that they consider to be important to them.

However, for modern investors, certain criteria may be more important than traditional risk/return on investment. The system 100 described herein may provide an ability allow investors 110 to make socially-conscious investments that take into consideration certain user factors that are their “core values” (e.g., stances on political issues, environment, religion) received or derived from various sources (e.g., survey, social network posts, web site visits, investment institution profile, behavioral modeling). The system 100 may then assist the investor 110 in portfolio management, taking into account these user factors, that is, the investor's core values.

In order to assist the investor 110, an investor social profile builder 140 may be utilized to build the investor's social profile 150, based on user/social profile related information 115. The social profile 150 may comprise a plurality of social factors 152 that are each assigned a weight 152a reflecting an importance of the social factor 152 (e.g., political affiliations, environmental impacts, religious leanings) to the investor 110. The investor social profile builder 140 may utilize a variety of mechanisms and the user/social profile related information 115 in order to create the social profile 150.

In one configuration, the investor social profile builder 140 may collect user/social profile related information 115 for the investor 110 from the network using social media 192 and social network information, including information from, for example, Facebook, Twitter, LinkedIn, Pinterest, etc., and, if the investor 110 allows access to their profile, may make deductions based on liked pages, groups joined, companies followed, purchases (e.g., via a credit card), their own computer (e.g., web sites visited) and the like. It may also collect user background data (e.g., job experience, education, dating sites). It may then evaluate the social input data 115, using, for example, behavior models, scoring the investor 110 on each of many social topics for the social profile 150.

In another configuration, the investor 110 may be provided with a user survey in a form, for example, of a questionnaire, either paper or on-line, for example, via a web browser accessing a web page or a social media interaction, such as a Facebook quiz, covering the social factors 152 possibly along with initial weighting values 152a on various criteria that may then be presented to the investor to confirm or alter core values. Thus, when the investor 110 fills out the questionnaire, the answers may provide information 115 usable to create the investor social profile 150. The above approaches may be combined as well. For example, based on the social media 192 input, the questionnaire may be pre-filled with estimated answers, which the investor may modify. The investor may then be allowed to configure a relative importance of various social topics in their profile, or the investor social profile builder may estimate the relative importance that is used to weight 152a the social factors 152, by, for example, a number of times keywords are mentioned or present in posts, contents of groups, etc. linked web pages, or other intelligent parsing.

A company/financial instrument social profile builder 160 may be used to score various companies or financial instruments on a plurality of social factors 172 related to the social factors 152 of the investors' social profiles 150, the social factors 172 also comprising respective weights 172a based on company/financial instrument-related information 117.

The social factors 172 may be based on inputs 117 about companies and investment items obtained from public systems 190 and include social media 192 and other public sources 194, such as public news servers, data feeds and databases (e.g., CNN, NY Times, Wall Street Journal), user/investor ratings (e.g., evaluations of a company provided by individuals, such as other users or the general public), government filings, such as 10Ks, mission statements, press releases, and other publicly available reporting data, and analyst/critic research. The analysis may look for a frequency of particular keywords, relationships with other entities, or a quantity of news available by scraping the web. The company social profile builder 160, in a configuration, may make use of artificial intelligence techniques, and the evaluations may be further adjusted by a reviewing person. It may determine where a company is making investments or take into account marketing campaigns. In one configuration, the investor 110 may select trusted input sources for company input feeds.

A plurality of company/financial instrument profiles 170 may be provided (reference nos. 170.1-170.n may be referred to herein as reference no. 170, either collectively or representatively).

The company/financial instrument profile 170 could be created and maintained for all investors 110, based collectively on the social factors 152 of the social profiles 150 for all investors, or could be created for a particular investor 110 based on social factors 152 of that investor's particular social profile 150.

An investment opportunity evaluation component 180 may then provide investment opportunities to the investor 110 based on how various companies align with the investor's core values by considering the respective social factors 152, 172 and their respective weightings 152a, 172a (how important the social factor is to the investor with respect to how significant the company is with respect to that particular social factor). This may be achieved by comparing the social factors 152 in the investor's social profile 150 with the social factors 172 in the company/financial instrument profile 170 and applying some function to the weightings 152a, 172a. For example, if the investor has indicated that green technology is a social factor of interest, and has designated it as being important (high weight), then a company GreenCo, which is a very environmentally conscious green energy supply company, and which also has a high weight for the green technology social factor, could be determined to be a good match for the investor.

Identifiers for companies and/or financial instruments may be sent to the investor 110. The investor 110 may then select an identifier for the company or financial instrument of interest, and optionally provide instructions for modifying their portfolio, including, for example, an amount of the investment element to purchase (such as shares of stock). The selected identifier and optional instructions may be sent to the provider system 120 in a purchase request. The provider system 120, upon receiving the purchase request, may then modify the investment portfolio 130, for example, by making a purchase related to the identifier and in accordance with any instructions provided.

The above example uses a single social factor in common with the investor social profile 150 and the company profile 170. However, it is also possible to perform a more complex multi-factor analysis that takes all or some of the social factors and weights 152, 152a of the investor social profile 150 and all of the social factors and weights 172, 172a of the company/financial instrument profile 170 into account to produce an overall score for the company. Thus, a company that aligns with three highly weighted investor social factors 152 will receive higher visibility to the investor than a company that aligns with only one.

A mutual fund typically comprises investment instruments from a number of different sources or companies. In that regard, the social factors and weightings 172, 172a for the mutual fund may be determined based on the fund as a whole, or may be calculated based on the constituent components of the mutual fund and their representation in the mutual fund. For example, if a mutual fund comprises 75% stock shares of GreenCo, then it is likely the mutual fund will have a high weight for the green technology social factor. However, this weighting may be reduced if other non-green companies are included in the mix or if the percentage of GreenCo stock in the fund is reduced.

The investment opportunity evaluation component 180 may filter investment suggestions to the investor 110 based on companies' scores. A predefined threshold (e.g., one that is set prior to use, such as in a configuration setting) may be established such that companies receiving a composite score below the threshold are not presented to the investor 110. In another configuration, the companies may be presented to the investor 110 in ranked order. The presentation could allow the investor 110 to select a subset of new investment instruments, such as stocks, mutual funds, and so on, and quantities or percentages that should go into their new portfolio, based on the degree of similarity between the investor's social profile 150 and a particular company's, mutual fund's, or other entity's profile 170. As defined herein, other entities can be broad and inclusive, including government entities (e.g., for bonds and other government-issued instruments). The investor or system may rank the subset of companies based on the similar factors. The provider system 120 may then provide financial data to the investor by evaluating the companies as investment opportunities.

In some instances, it is possible that the contents of a particular piece of information could vary, based on the perspective of the investor 110. In this case, it may be beneficial simply to provide the investor 110 with access to view the information (via, e.g., email, hyperlink, etc.) and possibly solicit a response with regard to that company and any impact that it might have on the investor's 110 portfolio 130.

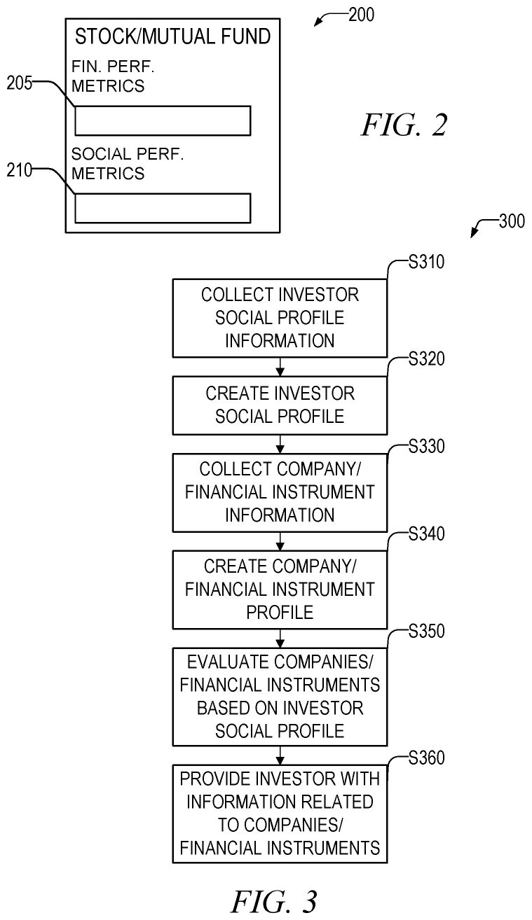

FIG. 2 is a screen shot 200 in which an evaluation presents both the financial performance metrics 205, which may be a traditional financial performance display, along with the social performance metrics 210 so that the investor 110 may evaluate the impact of their social decisions based on both the social scoring and financial scoring of the company, fund, or other instrument. Additionally, the sources of information for the companies may be provided to the investor. The investment opportunity evaluation component 180 could do an analysis on an existing portfolio to let the investor 110 see how well their existing portfolio aligns with their social profile 150. Using this tool, an investor 110 may decide to take a smaller return on investment at a particular risk level to invest in something that is more in line with their social interests. The investor 110 could make immediate and substantial changes to their portfolio, based on the information provided, or utilize this tool over time to gradually adjust their portfolio so that it better aligns with their core values. To assist them, the investor 110 could be presented with information about costs to make various changes to their portfolio.

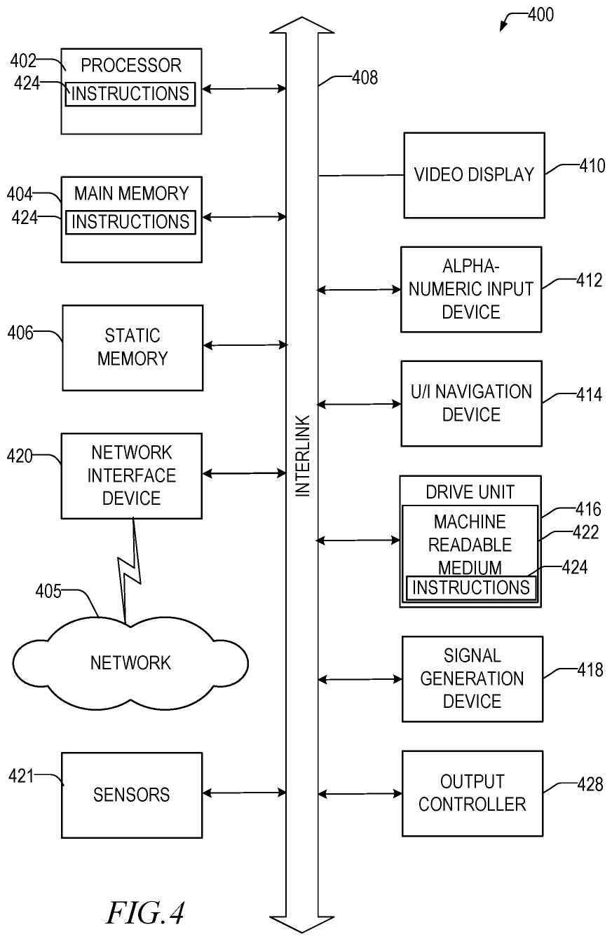

FIG. 3 is a flowchart that describes general process 300 that may be used by the system 100. In operation S310, the investor social profile information may be collected using any of the mechanisms discussed above, and from this, in operation S320, the investor's social profile 150 may be created. Similarly, in operation S330, company or financial instrument information may be collected, and, in operation S340, the company's or financial instrument's profile 170 may be created. In operation S350, the companies and/or financial instruments associated with an investor's social profile 150 and/or portfolio 130 may then be evaluated, based on respective weightings associated with the social factors in both the investor social profile 150 and the company/financial instrument profile 170. The investor, in operation S360, may then be provided with information about companies and/or financial instruments that are more closely related to social factors that the investor considers most important. The investor, may direct that their investment portfolio be revised, in operation S370, based on the information provided.

An investor 110 could utilize this tool regardless of whether they already have an account set up with the product or services provider. Thus, as part of an account set-up, the investor may be asked if they are interested in using this tool. If the investor indicates yes, then the process 300 described above could be initiated.

In another approach, an investor may use the process 300 for an existing account to build a watch list of stocks or other instruments that they are interested in potentially purchasing or selling. The system 100 may allow the investor to track them, set alerts on them, read news about them, set favorites, receive news from the system on them, and so on.

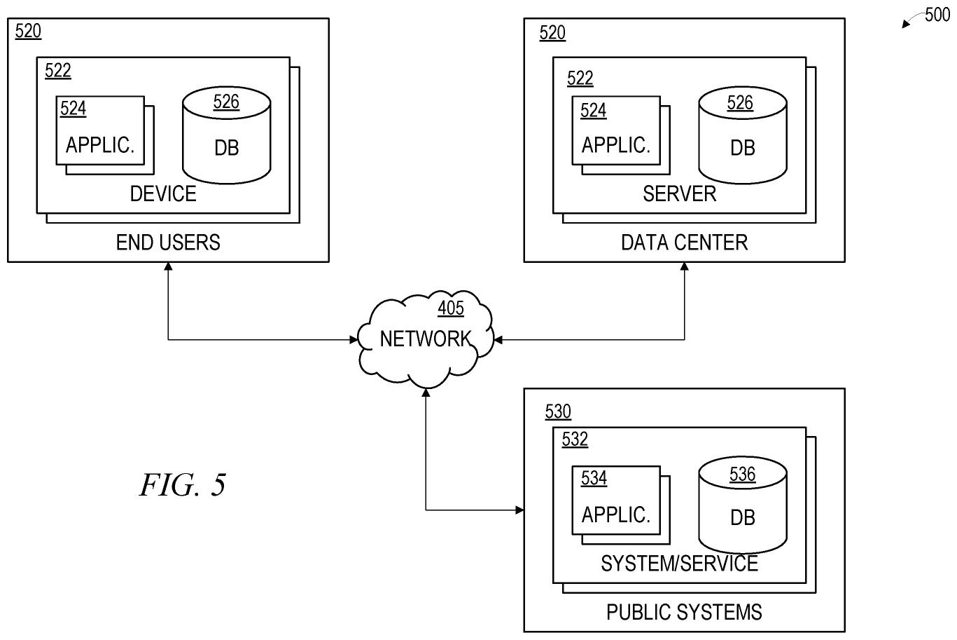

To describe some configurations in greater detail, reference is made to examples of hardware structures and interconnections usable in the designs of the present disclosure. FIG. 4 is a block diagram illustrating a machine that may be a computer on which various processes described herein may be performed. The machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example described herein, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB)), parallel, or other wired or wireless (e.g., infrared (IR), near field communication (NFC), etc.) controller connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over the communications network 405 using a transmission medium via the network interface device 420. The term “transmission medium” is defined herein to include any medium that is capable of storing, encoding, or carrying instructions for execution by the machine, and includes digital or analog communications signals or other medium to facilitate communication of such software.

The machine 400 may communicate with one or more other machines 400 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, virtual private networks (VPN), or any other way of transferring data between machines 400. In an example, the network interface device 420 may include one or more physical jacks (e.g., Ethernet, coaxial, or phone jacks) or one or more antennas to connect to the communications network 426.

In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

A wide variety of computing devices may constitute a machine 400, as described herein. The following list includes a variety of devices that may fit the definition of a machine 400: a personal data assistant (PDA), a cellular telephone, including a smartphone, a tablet computing device, a laptop computer, a desktop computer, a workstation, a server computer, a mainframe computer, and the like.

FIG. 5 is a block diagram of a distributed system 500 that may include a client-server architecture or cloud computing system. Distributed system 500 may have one or more end users 510. An end user 510 may have various computing devices 512, which may be machines 300 as described above. The end-user computing devices 512 may comprise applications 514 that are either designed to execute in a stand-alone manner, or interact with other applications 514 located on the device 512 or accessible via the network 405. These devices 512 may also comprise a data store 516 that holds data locally, the data being potentially accessible by the local applications 514 or by remote applications.

The system 500 may also include one or more data centers 520. A data center 520 may be a server 522 or the like associated with a business entity that an end user 510 may interact with. The business entity may be a computer service provider, as may be the case for a cloud services provider, or it may be a consumer product or service provider, such as a retailer. The data center 520 may comprise one or more applications 524 and databases 526 that are designed to interface with the applications 514 and databases 516 of end-user devices 512. Data centers 520 may represent facilities in different geographic locations where the servers 522 may be located. Each of the servers 522 may be in the form of a machine(s) 400.

The system 500 may also include publicly available systems 530 that comprise various systems or services 532, including applications 534 and their respective databases 536. Such applications 534 may include news and other information feeds, search engines, social media applications, and the like. The systems or services 532 may be provided as comprising a machine(s) 400.

The end-user devices 512, data center servers 522, and public systems or services 532 may be configured to connect with each other via the network 405, and access to the network by machines may be made via a common connection point or different connection points, e.g. a wireless connection point and a wired connection. Any combination of common or different connections points may be present, and any combination of wired and wireless connection points may be present as well. The network 405, end users 510, data centers 520, and public systems 530 may include network hardware such as routers, switches, load balancers and/or other network devices.

Other implementations of the system 500 are also possible. For example, devices other than the client devices 512 and servers 522 shown may be included in the system 500. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 522.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to be illustrative, and not restrictive. For example, the above-described examples (or one or more aspects/configurations thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it should not be used to interpret or limit the scope or meaning of the claims.

Also, in the above Detailed Description, various features may be grouped together to streamline the disclosure. However, the claims cannot set forth every feature disclosed herein, as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the claims, along with the full scope of equivalents to which such claims are entitled.

1. A computer-implemented method for providing items of interest to a user, comprising, with a processor of a provider system:
creating a current user collection comprising a plurality of current user elements;
receiving user profile information from a user associated with the current user collection, wherein the user profile information includes a current portfolio of the user and wherein the current portfolio includes a set of element providers;
receiving social media data from social media accounts associated with the current user, wherein the social media data includes social media interactions of the current user and each social media interaction is associated with a social profile and wherein each social profile includes social topics determined by keyword usage in social media output associated with the social profile;
inputting the social media interactions the current user has provided into a behavior model;
based on an output of the behavior model, identifying a set of social media topics for the current user, wherein the set of social topics for the current user is based on using a behavior model with the social media interactions the current user has provided a positive indication as input to the behavior model, wherein the set of social topics for the current user is determined from the social topics of each social profile associated with the social media interactions;
assigning a weight for each of the social topics from the set of social topics for the current user based on an amount of positive indications the current user has provided related to each of the social topics from the set of social topics for the current user;
storing the set of social topics for the current user and their respective weights in a user profile that is stored in a memory of the provider system;
building an element provider profile data structure for each element provider in a plurality of element providers, wherein each element provider profile data structure includes element provider factors determined by a collection of social factors for investors of the element provider;
assigning an element provider factor weight for each of the element provider factors based on the collection of social factors for investors of the element provider;
storing the plurality of element provider factors and their respective weights in the element provider profile data structure that is stored in the memory of the provider system;
determining, for each element provider of the plurality of element providers, a matching score between the user profile and a respective element provider by determining a degree of similarity between the set of social topics for the current user with respective weights and the element provider factors of each element provider profile data structure with respective element provider factor weights;
displaying, in a graphical user interface (GUI), a ranking of the element providers based on the respective matching score, including the respective matching score;
displaying, in the GUI, a list of element providers and respective matching score for the element provider, wherein the list of element providers is based on the set of element providers of the current portfolio;
receiving an indication of a selection from the ranking of the element providers from the user; and
modifying the current portfolio to include an element provider associated with the selection from the ranking of the element providers.

2. The method of claim 1, wherein:
the user is an investor;
the current user collection comprising a plurality of current user elements is an investment portfolio comprising a plurality of investment elements;
the user profile information is investor social profile information;
the set of social topics for the current user are investor social factors;
the element providers are individual, company, or government entities that provide investment elements; and
the element provider profile data structure includes individual, company, or government entity social profile information.

3. The method of claim 2, wherein modifying the current user collection that is an investment portfolio comprises:
receiving a purchase request from the investor for purchasing a requested investment element related to the element provider; and
purchasing the requested investment element and adding it to the current user collection.

4. The method of claim 2; wherein the investment elements are at least one of stocks, bonds, and mutual funds.

5. The method of claim 4, wherein the investment elements include a mutual fund, and the matching score is based on general information about the mutual fund as a whole.

6. The method of claim 4, wherein the investment elements include a mutual fund, and the matching score is based on information from constituent components of the mutual fund.

7. The method of claim 2; wherein the social factors are related to at least one of politics, environment, and religion.

8. The method of claim 1, further comprising:
presenting a user survey to the user;
wherein receiving user profile information comprises receiving the user survey in an answered form.

9. The method of claim 8, wherein presenting the user survey comprises at least one of:
presenting a physical copy of the user survey to the user;
presenting a web-browser based copy of the user survey to the user; and
presenting a social media-based copy of the user survey to the user.

10. The method of claim 1, wherein the assigning of the weight to the set of social topics for the current user is based on a frequency of keywords in the received user profile information.

11. The method of claim 1, wherein element provider factors are based on data from at least one of public news servers, public data feeds, public databases, user ratings, and government filings.

12. The method of claim 1, further comprising:
determining a plurality of element providers and respective matching scores between the user profile and a respective element provider;
filtering the plurality of element providers having a matching score meeting or exceeding a predefined threshold; and
outputting only the filtered elements and their matching scores to the user.

13. A provider system comprising:
a hardware processor;
a network interface connected to the hardware processor that is connected to a network;
a non-volatile memory connected to the hardware processor and the network interface comprising:
a user collection comprising a plurality of user elements;
a user profile;
a plurality of element provider profiles, each comprising a plurality of element provider factors and element factor weights;
instructions executable by the processor, comprising:
a user profile builder that is configured to:
receive user profile information from a user associated with the user collection, wherein the user profile information includes a current portfolio of the user and wherein the current portfolio includes a set of element providers;
receive social media data from social media accounts associated with the user, wherein the social media data includes social media interactions of the user and each social media interaction is associated with a social profile and wherein each social profile includes social topics determined by keyword usage in social media output associated with the social profile;
inputting the social media interactions the current user has provided into a behavior model;
based on an output of the behavior model, identifying a set of social media topics for the current user, wherein the set of social topics for the user is based on using a behavior model with the social media interactions the user has provided a positive indication as input to the behavior model, wherein the set of social topics for the user is determined from the social topics of each social profile associated with the social media interactions;
assign a weight for each of the social topics from the set of social topics for the user based on an amount of positive indications the user has provided related to each of the social topics from the set of social topics for the user; and
store the set of social topics for the user and their respective weights in the user profile that is stored in the memory; and
an element opportunity evaluation component that is configured to:
build an element provider profile data structure for each element provider in a plurality of element providers, wherein each element provider profile data structure includes element provider factors determined by a collection of social factors for investors of the element provider;
assign the element provider factor weight for each of the element provider factors based on the collection of social factors for investors of the element provider;
store the plurality of element provider factors and their respective weights in the element provider profile data structure that is stored in the memory; and
determine, for each element provider of the plurality of element providers, a matching score between the user profile and a respective element provider by determining a degree of similarity between the set of social topics for the user with their respective weights and the element provider factors of each element provider profile data structure with respective element provider factor weights;
the instructions executable by the processor, further comprising instructions configured to:
display, in a graphical user interface (GUI), a ranking of the element providers based on the respective matching score, including the respective matching score;
display, in the GUI, a list of element providers and respective matching score for the element provider, wherein the list of element providers is based on the set of element providers of the current portfolio;
receive an indication of a selection from the ranking of the element providers from the user; and
modify the current portfolio to include an element provider associated with the selection from the ranking of the element providers.

14. The provider system of claim 13, wherein:
the user is an investor;
the current user collection comprising a plurality of current user elements is an investment portfolio comprising a plurality of investment elements;
the user profile information is investor social profile information;
the set of social topics for the current user are investor social factors;
the element providers are individual, company, or government entities that provide investment elements; and
the element provider profile data structure includes individual, company, or government entity social profile information.

15. The provider system of claim 14, wherein the investment elements include a mutual fund, and the matching score is based on at least one of: a) general information about the mutual fund as a whole; and b) information from constituent components of the mutual fund.

16. The provider system of claim 13, wherein the network interface comprises an element provider interface configured to receive information obtained from a public source that is at least one of public news servers, public data feeds, public databases, user ratings, and government filings.

17. The provider system of claim 13, wherein the network interface comprises a user profile information interface configured to receive information obtained from the user related to the plurality of user factors.

18. The provider system of claim 17, wherein:
the network interface is further configured to receive a purchase request from the user for purchasing a requested element related to the element provider; and
the instructions executable by the processor are further configured to purchase the requested element and add it to the user collection.

19. The provider system of claim 13, wherein assigning of the weight to the set of social topics for the current user is based on a quantity of keywords in the received user profile information.

20. A non-transitory computer-readable storage medium, the computer-readable storage medium including instructions that when executed by a computer of a provider system, cause the computer to:
create a current user collection comprising a plurality of current user elements;
receive user profile information from a user associated with the current user collection, wherein the user profile information includes a current portfolio of the user and wherein the current portfolio includes a set of element providers;
receive social media data from social media accounts associated with the current user, wherein the social media data includes social media interactions of the current user and each social media interaction is associated with a social profile and wherein each social profile includes social topics determined by keyword usage in social media output associated with the social profile;
inputting the social media interactions the current user has provided into a behavior model;
based on an output of the behavior model, identifying a set of social media topics for the current user, wherein the set of social topics for the current user is based on using a behavior model with the social media interactions the current user has provided a positive indication, as input to the behavior model, wherein the set of social topics for the current user is determined from the social topics of each social profile associated with the social media interactions;
assign a weight for each of the social topics from the set of social topics for the current user based on an amount of positive indications the current user has provided related to each of the social topics from the set of social topics for the current user;
store the set of social topics for the current user and their respective weights in a user profile that is stored in a memory of the provider system;
build an element provider profile data structure for each element provider in a plurality of element providers, wherein each element provider profile data structure includes element provider factors determined by a collection of social factors for investors of the element provider;
assign an element provider factor weight for each of the element provider factors based on the collection of social factors for investors of the element provider;
store the plurality of element provider factors and their respective weights in element provider profile data structure that is stored in the memory of the provider system;
determine, for each element provider of the plurality of element providers, a matching score between the user profile and a respective element provider profile by determining a degree of similarity between the set of social topics for the current user with respective weights and the element provider factors of each element provider profile data structure with respective element provider factor weights;
display, in a graphical user interface (GUI), a ranking of the element providers based on the respective matching score, including the respective matching score;
display, in the GUI, a list of element providers and respective matching score for the element provider, wherein the list of element providers is based on the set of element providers of the current portfolio;
receive an indication of a selection from the ranking of the element providers from the user; and
modify the current portfolio to include an element provider associated with the selection from the ranking of the element providers.
